(19) United States
(12) Patent Application Publication
(10) Pub. No.: US 2003/0013371 A1
(43) Pub. Date: Jan. 16, 2003

(54) Process for forming soft, drapeable nonwoven fabric

(75) Inventors: Kyra Dorsey, Charlotte, NC (US); Keith Wilbourn, Matthews, NC (US); Kuo-Shu Edward Chang, Charlotte, NC (US); John Charles Norton, Indian Trail, NC (US); Valeria Griep Erdos, Porto Alegre (BR)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/126,559

(22) Filed: Apr. 19, 2002

Related U.S. Application Data
(60) Provisional application No. 60/285,185, filed on Apr. 20, 2001.

(51) Int. Cl. B32B 5/26; D04H 3/02; D04H 3/00; D04H 5/00

(52) U.S. Cl. 442/401; 264/103; 264/171.13; 442/382; 442/340; 442/345

(57) ABSTRACT

A method of making a spunbond nonwoven fabric embodying the principles of the present invention contemplates use of an aliphatic-aromatic polyester resin, such as Eastar BioGP, for formation of fabrics which exhibit desirable softness and drapeability characteristics, excellent gamma-radiation stability and, where required, desirable elasticity. In distinction from previous formation techniques, the present invention contemplates formation of such fabrics by spunbonding at relatively low filament spinning speeds, thus facilitating practice of the present invention with generally available and conventional spunbonding equipment.

### TECHNICAL FIELD

The present invention relates generally to formation of spunbond, nonwoven fabrics, and more particularly to a process for forming spunbond fabrics from an aliphatic-aromatic polyester resin which process can be cost-effectively practiced on convention spunbond equipment, with the resultant fabric exhibiting desirable properties including softness and drapeability.

### BACKGROUND OF THE INVENTION

Nonwoven fabrics formed from melt-extruded polymeric fibers and filaments have found widespread application by virtue of the manner in which the physical characteristics and properties of such fabrics can be selectively engineered. For a number of applications, softness and drapeability of a fabric are key characteristics, with fabrics exhibiting elasticity (i.e., elongation and recovery) being particularly well suited for certain uses.

Heretofore, efforts have been made to form nonwoven fabrics exhibiting elasticity by the spunbond process, that is, the process wherein melt-extruded filaments are extruded, drawn, and collected to form a fabric construct. In particular, fabrics formed from an aliphatic-aromatic polyester (commercially available under the name Eastar BioGP, available from Eastman Chemical Co.) have been made by a process as generally disclosed in U.S. Pat. No. 6,183,684, sometimes referred to as the Ason or Ason/Hills process. This process has provided fabrics exhibiting desirable physical properties, but has typically required filament spinning speeds on the order of 3500 to 4500 meters/minute. Fabric basis weights have typically been on the order of 45 to 110 grams/meter², with filament diameters ranging from 11 to 13 microns.

It has been recognized that formation of nonwoven fabrics from an aliphatic-aromatic polyester resin, such as described above, is desirable in order to obtain the desired softness, drapeability, and for some applications, elasticity, which this polymer can provide. Gamma-radiation stability exhibited by this polymer is also desirable for some medical-related applications. However, it has been further recognized that cost-effective formation of such fabrics is greatly facilitated by spunbond formation of such fabrics through the use of conventional and widely available spunbonding equipment, sometimes referred to as Reicofil II equipment. The present invention is directed to production of such nonwoven fabrics, with their economical formation facilitating use for widespread applications.

### SUMMARY OF THE INVENTION

A method of making a spunbond nonwoven fabric embodying the principles of the present invention contemplates use of an aliphatic-aromatic polyester resin, such as Eastar BioGP, for formation of fabrics which exhibit desirable softness and drapeability characteristics, excellent gamma-radiation stability and, where required, desirable elasticity. In distinction from previous formation techniques, the present invention contemplates formation of such fabrics by spunbonding at relatively low filament spinning speeds, thus facilitating practice of the present invention with generally available and conventional spunbonding equipment.

In accordance with the present method, a spinneret assembly is provided for spunbond formation of the present nonwoven fabric. A molten aliphatic-aromatic polyester resin is provided, and is extruded from the spinneret assembly to form filaments. The filaments are drawn and collected to form the nonwoven fabric, with the spinneret assembly operated at a spinning speed of no more than about 3000 meters/minute, with a presently preferred spinning speed between about 930 and 1140 meters/minute. Fabrics formed in accordance with the present invention are formed from filaments having diameters from about 12 to 20 microns, with fabrics having a basis weight between 25 and 100 grams/meter².

A nonwoven fabric formed in accordance with the present invention which is formed substantially entirely of the aliphatic-aromatic polyester resin desirably exhibits, in a machine direction, at least about 60% recovery at 50% elongation. However, for those applications where elasticity is not required, the present invention contemplates formation of a composite fabric by first providing a spunbond polyester base web, with the filaments of the aliphatic-aromatic polyester resin collected on the base web to form the nonwoven fabric. Notably, the aliphatic-aromatic polyester filaments self-adhere to the spunbond base web, without resort to use of binders or other additional components, with an integrated, composite nonwoven fabric thus being very efficiently formed.

Other features and advantages of the present invention will become readily apparent from the following detailed description, and the appended claims.

### DETAILED DESCRIPTION

While the present invention is susceptible of embodiment in various forms, there is shown in the drawings, and will hereinafter be described, presently preferred embodiments of the invention, with the understanding that the present disclosure is to be considered as exemplifications of the invention, and is not intended to limit the invention to the specific embodiments illustrated.

Nonwoven fabrics formed from an aliphatic-aromatic polyester resin such as Eastar BioGP, available from Eastman Chemical Co., have been recognized as exhibiting desirable softness and drapeability characteristics, with these types of fabrics being particularly suited for medical-related applications, in view of their gamma-radiation stability. Additionally, fabrics formed from this type of polyester have been found to exhibit bio-degradability under a compost environment.

Heretofore, spunbond nonwoven fabrics formed from the above-described polyester resin have been formed in accordance with the teachings of U.S. Pat. No. 6,183,684, hereby incorporated by reference. However, equipment operated in accordance with this patent's teachings generally operates at relatively high filament spinning speeds, on the order of 3500 to 4500 meters/minute.

Notably, it has been determined that fabrics incorporating the above-described aliphatic-aromatic polyester resins can be efficiently and cost-effectively formed at relatively low filament spinning speeds, such as through the use of conventional spunbond equipment, sometimes referred to as Reicofil II equipment.

Practice of the present invention on such Reicofil II equipment entails providing a spinneret assembly, and providing molten aliphatic-aromatic polyester resin (such as Eastar BioGP), with the polyester resin being extruded from the spinneret assembly to form filaments. The filaments are collected to form a nonwoven fabric, with the present invention contemplating that the spinneret assembly is operated at a spinning speed of no more than about 3000 meters/minute. More preferably, the spinneret assembly is operated at a spinning speed of between about 930 and 1140 meters/minute. Filaments formed in accordance with the present method have diameters from about 12 to 20 microns, with a fabric basis weight between about 25 and 100 grams/meter².

The appended Table 1 shows test data for fabrics formed in accordance with the present invention. Samples 1.1 through 1.7 are fabrics of varying basis weights, as noted, with these fabrics formed entirely from the Eastar BioGP aliphatic-aromatic polyester resin. Drape, tensile, elastic, and softness (lower values better) properties are set forth.

A further aspect of the present invention contemplates that the above-described aliphatic-aromatic polyester resin can be combined with a base spunbond web formed from a typical polyester polymer to form a composite nonwoven fabric. In the preferred practice form, this composite fabric is formed by collecting the extruded and drawn aliphatic-aromatic polyester resin filaments and a base spunbond polyester web. The base web provides a first web layer of the composite fabric, with the filaments collected thereon self-adhering to form a second web layer. Such a composite fabric is suitable for those applications where fabric elasticity is not critical, with the softness and drapeability imparted by the aliphatic-aromatic polyester resin desirably evident in the resultant composite fabric.

Samples 1.8 through 1.11 in the appended Table 1 shows process conditions and fabric properties for composite fabrics formed in accordance with the present invention, wherein a base polyester spunbond web having an 18 grams/meter² basis weight was employed.

Selected ones of the fabric samples of the present invention have been compared to fabrics formed by the above-described Ason process, with this comparative test data set forth in appended Tables 2 and 3. As will be observed, fabrics formed in accordance with the present invention exhibited superior elastic properties, showing at least about 60% recovery after 50% elongation. These fabrics also exhibited desirable softness, drapeability, and gamma-radiation stability.

In comparison to the Ason formation process, the process of the present invention has been found to permit formation of fine diameter polymer filaments at relatively low fiber spinning speeds, with a relatively reduced amount of draw required. Fabrics made up to even large filament diameters (greater than 18 microns) were found to exhibit a desirably soft feel, with the use of the contemplated aliphatic-aromatic polyester resin resulting in fabrics exhibiting better drape and softness than typical polyester spunbond fabrics, which fabrics typically exhibit good drape and softness.

Single layer fabrics formed in accordance with the present invention from aliphatic-aromatic polyester resin have been found to desirably exhibit elastic recovery, in the machine direction (MD), of at least about 60%, generally 60%-70%, at 50% elongation. The fabrics also exhibit elongation of greater than 90%, with most samples exhibiting elongation much greater than 100% in both the machine-direction and cross-direction. Typically, the desired elastic recovery is usually found only in nonwoven articles in composite form.

Softness characteristics are superior to polyethylene/polyester/polypropylene spunbond composite fabrics, with softness equivalent to polyethylene/polypropylene bi-component filament fabrics at the finest diameter. Polyethylene/polypropylene spunbond bi-component filaments typically have an 11 micron diameter, with the present aliphatic-aromatic polyester resin fabrics having filaments with a diameter range of 12 to 20 microns, more preferably 13 to 19 microns.

When the present invention is used to form a composite fabric, including a spunbond polyester base web, and an aliphatic-aromatic polyester resin layer juxtaposed thereto, it has been found that the aliphatic-aromatic polyester resin easily self-bonds to the polyester spunbond layer at low bonding temperatures, in a range of 75° to 85° C., with 75° C. being presently preferred. The composite structure lends softness characteristics to the polyester filament base web, with improved drapeability, with the resultant structure also exhibiting desirable gamma-radiation stability. This makes the composite fabric suitable for medical applications, with it being contemplated that such fabrics can be used for hygienic applications by bonding the aliphatic-aromatic polyester resin web to a polyolefin spunbond fabric or film. Such a composite structure can be used for a disposable absorbent product backsheet exhibiting improved softness, or for formation of relatively soft leg cuffs of such products.

It is contemplated that fabrics formed in accordance with the present invention can have widespread applications, which can include the following.

A medical bandage wrap product can be formed from a web formed substantially entirely of the aliphatic-aromatic polyester resin. Such a bandage can be formed with a basis weight ranging from 20 to 200 grams/meter², depending on the application. The use of this resin would facilitate convenient use of such a bandage product due to its elasticity. Notably, formation of this type of product is facilitated since processing can be effected without the extruded filaments sticking together during spunbonding. Heretofore, elastomeric polymers (in non-bi-component filament form) did not lend themselves to such products due to the stickiness or tackiness of the extruded filaments. This characteristic undesirably resulted in adherence to the spunbond processing equipment, and also undesirably resulted in the lack of uniformity of the fabrics formed due to bundles of the filaments sticking together.

It is further contemplated that fabrics formed in accordance with the present invention could be used as landscaping or geo-textile fabrics, which would tend to degrade and disappear within a year's time. Such fabrics can preferably be formed by spunbonding, and can be formulated to contain fertilizers, added either during melt processing, and/or as a topical treatment to the fabric. The addition of fertilizers or like additives within the fabric results in these additives blooming to the fabric surface, due to the changing concentration, and acts as an aid to soil and plants as the aliphatic-aromatic polyester resin fabric disintegrates.

As noted, use of the present fabrics for medical garments and fabrics (including gowns, drapes, sleeves, etc.) is particularly contemplated. Gamma-radiation stability, drapeability, softness, and elasticity are among the desirable properties for such fabrics, and lend comfort to the wearer. Such fabrics benefit from the softness of the aliphatic-aromatic polyester resin on one or both sides of a composite fabric structure, such as in combination with common medical fabrics or a polyester spunbond web. In a non-composite form, use of the aliphatic-aromatic polyester resin provides the desired softness and elastic recovery, which would facilitate its application for joint areas on garments.

As noted, the present fabric can be employed as the backsheet of a disposable diaper or like disposable absorbent product. The aliphatic-aromatic polyester resin fabric provides a soft backsheet through bonding of the fabric to a typical spunbond, carded, or film material to produce a composite fabric with an extremely soft surface. Such a composite structure exhibits reduced pilling and fuzzing, a benefit for use with infants. While fabrics formed from the present aliphatic-aromatic polyester resin do abrade, testing has shown that the fabric tends to roll and stick to itself, rather than pilling and/or fuzzing.

Apart from use as a diaper backsheet, a nonwoven fabric formed in accordance with the present invention can be used to form a stretch-fit diaper. The stretch and recovery facilitates such a product to exhibit a “custom fit” about an infant or adult user, with the use of such fabric acting to present leakage and thereby increasing containment efficiency. Again, softness provides further comfort for a wearer, and can act to reduce undesirable noise.

Apart from an overall diaper, fabrics formed in accordance with the present invention can be used for formation of elastic tabs for diapers. The aliphatic-aromatic polyester resin lends itself to formation of a totally spunbond tab which exhibits the desired elastic recovery. Although such a construct does not exhibit the same level of recoverability as current tab composites (which have above 80% recovery after three cycles at 100% elongation), an aliphatic-aromatic polyester resin spunbond tab has equivalent or acceptable recovery at a reduced elongation. It is believed that such a fabric formed in accordance with the present invention is the only single component nonwoven fabric which provides such elastic qualities.

Apart from medical apparel applications, the fabrics formed in accordance with the present invention can be used for protective apparel and fabrics. The above-described qualities of fabrics formed from the present aliphatic-aromatic polyester resin, including gamma-radiation stability, drapeability, softness, hydrophilicity, and pilling/fuzzing resistance, are all desirable for protective apparel fabrics. Softness, drapeability, and elasticity enhance the comfort for the wearer of such apparel. As will be recognized, the relative reduction in pilling and fuzzing is a desirable benefit for use of the present fabrics for apparel for “clean room” facilities. The hydrophilicity of the aliphatic-aromatic polyester resin also facilitates absorption of small quantities of perspiration from the user. Protective apparel can be formed from fabrics which position the aliphatic-aromatic polyester resin component on the skin side of the apparel, in combination with another protective apparel fabric. Again, use of the aliphatic-aromatic polyester resin fabric by itself is useful for joint areas on such protective apparel.

Other uses for the present fabrics include footwear, such as a medical slipper, or as use as an upper of a shoe, or as a shoe cover. The aliphatic-aromatic polyester resin lends itself for use as a shoe cover due to the high coefficient of friction developed when next to a flooring surface. The fabric's elastic nature allows snug fitting over shoes, as well as over feet (as a slipper).

Cosmetic pads/fabrics can also be formed from the present fabrics, where the softness exhibited by the fabrics is beneficial for applying and removing make-up.

Dusting and lint removal wipes can advantageously be formed from the present fabrics, with the slight tackiness of the aliphatic-aromatic polyester resin fabric assisting in removal of dust, while obviating the need for electrostatically charging the fabric, thus permitting use as an efficient lint remover.

From the foregoing, it will be observed that numerous modifications and variations can be effected without departing from the true spirit and scope of the novel concept of the present invention. The disclosure is intended to cover, by the appended claims, all such modifications as fall within the scope of the claims.

TABLE 1

| | | 1.1 | 1.2 | 1.6 | 1.7 | 1.8 | 1.11 |
|---|---|---|---|---|---|---|---|
| Test | units | single layer fabric | | | | composite fabric | |
| Basis Weight | (gsm) | 45 | 99 | 26 | 41 | 64 | 33 |
| Diameter | (microns) | 13.8 | 13.8 | 13.3 | 18.4 | 18.4 | 13.3 |
| MD Drape (JJMI-5083) | (g) | 3 | 19 | 1 | 1 | 14 | 8 |
| CD Drape | (g) | 2 | 12 | 1 | 1 | 6 | 1 |
| MD Tear (ASTM D-5733) | (g) | 2026 | 6704 | 1226 | 1701 | 3791 | 2408 |
| CD Tear | (g) | 2571 | 3477 | 1266 | 1431 | 2377 | 2367 |
| Tenacity-Strip | (MD + CD)/BW | 35 | 37 | 20 | 17 | 21 | 15 |
| MD Strip (ASTM 5035) | (g/cm) | 975 | 2157 | 326 | 388 | 881 | 358 |
| MD Strip Elongation | (%) | 108 | 116 | 86 | 130 | 42 | 329 |
| CD Strip | (g/cm) | 590 | 1498 | 205 | 304 | 487 | 141 |
| CD Strip Elongation | (%) | 122 | 156 | 89 | 157 | 80 | 63 |
| Tenacity-Grab | (MD + CD)/BW | 73 | 93 | 72 | 52 | 61 | 93 |
| MD Grab (ASTM D-5034) | (g/cm) | 1949 | 5735 | 915 | 1075 | 2124 | 1865 |
| MD Grab Elongation | (%) | 196 | 108 | 96 | 333 | 59 | 43 |
| CD Grab | (g/cm) | 1365 | 3448 | 979 | 1059 | 1789 | 1170 |
| CD Grab Elongation | (%) | 121 | 137 | 99 | 167 | 121 | 84 |
| MD-50% Elongation | (%) | 62 | 66 | 62 | 70 | | |
| MD-25% Elongation | (%) | 82 | 80 | 80 | 82 | | |
| MD-10% Elongation | (%) | 90 | 85 | 85 | 85 | | |
| CD-50% Elongation | (%) | 68 | 68 | 70 | 61 | | |
| CD-25% Elongation | (%) | 76 | 76 | 84 | 82 | | |
| CD-10% Elongation | (%) | 85 | 80 | 90 | 87 | | |
| Softness Test 1: Score | | 1.9 | 6.3 | 2.1 | 6.6 | | 4.3 |
| Softness Test 2: Score | | 1.8 | | 2.1 | 3.9 | | 3.4 |
| Abrasion (ASTM D-3884) | (g) | 0 | 0 | 0 | | 0 | |
| Air Permeability (ASTM D-737) | (cfm) | 374 | 117 | 728 | 620 | 266 | 421 |

TABLE 2

| | | | |
|---|---|---|---|
| Properties | SB Bio 1.1 | SB Bio 1.7 | Ason LW |
| Equipment | Reicofil II | Reicofil II | Ason |
| BW | 45 | 41 | 12.5 |
| Diameter | 13.8 | 18.4 | 12.5 |
| Softness | 3 | 5.8 | 5.1 |
| (avg score out of 9 samples | | | |
| from 10 panelists) | | | |
| Drape (Handleometer) md/cd | 3/2 | 1/1 | 1/2 |
| Elongation (%) | | | |
| MD | 108 | 130 | 71 |
| CD | 122 | 157 | 80 |
| Tenacity | 14 | 9 | 26 |
| (MDₜₑₙₛᵢₗₑ + CDₜₑₙₛᵢₗₑ)/BW | | | |
| Elastic Recovery | 62/68 | 70/61 | 52/46 |
| (50% elongation) | | | |

TABLE 3

| Properties | SB Bio 1.2 | Ason HW |
|---|---|---|
| Equipment | Reicofil II | Ason |
| BW | 99 | 119 |
| Diameter | 13.8 | 12.5 |
| Softness (avg score out of | 6.0 | 8.9 |
| 9 samples from 10 panelists) | | |
| Drape (Handleometer) | 19/12 | 12.3/11.5 |
| Elongation (%) | | |
| MD | 116 | 113 |
| CD | 156 | 112 |
| Tenacity (MDₜₑₙₛᵢₗₑ + CDₜₑₙₛᵢₗₑ)/BW | 17 | 27 |
| Elastic Recovery (50% elongation) | 62 | |

What is claimed is:

1. A method of making a spunbond, nonwoven fabric, comprising the steps of:
providing a spinneret assembly;
providing a molten aliphatic-aromatic polyester resin;
extruding said polyester resin from said spinneret assembly to form filaments; and
collecting said filaments to form said nonwoven fabric;
wherein said spinneret assembly is operated at a spinning speed of no more than about 3,000 meters/minute.

2. A method of making a nonwoven fabric in accordance with claim 1, wherein said spinneret assembly is operated at a spinning speed of between about 930 and 1140 meters/minute.

3. A method of making a nonwoven fabric in accordance with claim 1, wherein said filaments have diameters from about 12 to 20 microns, and said fabric has a basis weight between about 25 and 100 grams/meter².

4. A method of making a nonwoven fabric in accordance with claim 1, including:
providing a spunbond base web; and
collecting said filaments on said base web to form a composite nonwoven fabric.

5. A nonwoven fabric exhibiting extensibility and recovery, comprising:
a spunbond web of polymeric filaments, said filaments being formed from aliphatic-aromatic polyester resin;
said fabric exhibiting, in a machine direction, at least about 60% recovery at 50% elongation.

6. A nonwoven fabric in accordance with claim 5, wherein said polymeric filaments have diameters between about 12 and 20 microns, and said fabric has a basis weight between about 25 and 100 grams/meter².

7. A composite nonwoven fabric, comprising:
a base fabric web comprising spunbond polymer filaments forming a first fabric layer; and
a second fabric layer comprising spunbond aliphatic-aromatic polyester filaments self-adhered to said first layer.

8. A composite nonwoven fabric in accordance with claim 7, wherein said base fabric web comprises spunbond polyester filaments.
